(19) United States
(12) Patent Application Publication
(10) Pub. No.: US 2021/0137118 A1
(43) Pub. Date: May 13, 2021

(54) NEW USES OF 9-(3-DEOXY-BETA-D-RIBOFURANOSYL)ADENINE

(71) Applicant: Agroquimicos De Levante, S.A., Cheste (Valencia) (ES)

(72) Inventor: Silvio Gonella, Montà (IT)

(21) Appl. No.: 16/973,704

(22) PCT Filed: Jun. 12, 2019
(86) PCT No.: PCT/EP2019/065288

§ 371 Date: Dec. 9, 2020

(30) Foreign Application Priority Data
Jun. 13, 2018 (IT) 102018000006281

(51) Int. Cl. A01N 43/90

(52) U.S. Cl. CPC A01N 43/90

(57) ABSTRACT

The invention concerns the use of 9-(3-Deoxy-β-D-ribofuranosyl)adenine, a substance of natural origin present in the entomopathogenic fungus Cordyceps spp., as insecticide, in all its forms thereof. Methods for killing insects on a substrate, using an effective amount of 9-(3-Deoxy-β-D-ribofuranosyl)adenine, are also described.

### FIELD OF THE INVENTION

The invention concerns the use of 9-(3-Deoxy-β-D-ribofuranosyl)adenine, a substance of natural origin present in the entomopathogenic fungus Cordyceps spp., as an insecticide or pesticide. Methods for killing insects present on a substrate by an effective amount of 9-(3-Deoxy-β-D-ribofuranosyl)adenine are also described.

### STATE OF THE ART

In the last decade, the landscape of European agriculture and agrochemistry is undergoing a great evolution; many insecticidal active ingredients and the corresponding commercial formulation have been withdrawn due to their accentuated toxicity on humans and the environment, or for the low affinity/selectivity against pollinating insect; for this reason, in recent years, research has focused on substances of natural origin (botanicals) or micro-organisms, which guarantee a result while safeguarding human health and minimizing environmental impact. Technologies complementary to chemical defence, and the introduction of useful arthropods in protected cultivation, increase the need to develop new solutions wherein the formulation, besides being effective on parasites, must be selective towards non-target insects. In recent years, the commercial formulations based on microorganisms mostly used for the control of agricultural insects are Bacillus thuringensis and Beauvaria bassiana. The first one is able to produce several Cry toxins (Cry 1Aa, CryAc, Cry 2A, etc.) which, in the form of crystals, are responsible for the larvicidal activity by leading to a change in the pH of the digestive tract and, therefore, to the dissolution thereof.

However, B. thuringensis is effective only in the case of ingestion by the insect in larval form, and the administration must be performed using solutions with acidic pH, with lower efficacy in the case of low temperatures. The second most widespread microorganism for fighting mites, thrips, aphids, and diptera is Beauvaria bassiana, an ascomycete that acts by contact as a result of conidiospores that germinate following adhesion to the insect cuticle (the fungus invades the body of the insect and feeds on the hemolymph allowing its development). This is effective only in the insect juvenile stages, and mostly as an ovicide in the case of red spider mite.

Cordycepin (9-(3-Deoxy-β-D-ribofuranosyl)adenine or 3-deoxyadenosine) is one of the main components of the Cordyceps spp. entomopathogenic fungi. This substance has been tested on various diseases in the medical field, and there are numerous publications reporting anti-viral or anti-tumor effects thereof. The Cordyceps fungus is present in nature with over 250 species, but the C. militaris species is characteristic of the Tibetan plateau areas and is the most known and used in Chinese folk medicine. The characteristics of the genus Cordyceps, namely that of entomopathogenic fungus, already recall the possible use of this bio-insecticide in agriculture, but unlike other entomopathogenic microorganisms, whose effect is due to different active substances (toxins) produced by the micro-organism which have together a synergistic effect, in Cordyceps the active substance having larvicidal effect is presumably only one. Moreover, the insecticidal activity of Cordycepin can be explained and is already present, even without a direct development of the fungus, which is on the contrary necessary/needed for the enthomopathogenic microorganisms already on the market.

Kim J. R. et al (Pest.Manag.Sci.58 :713-717 (2002)) describe the larvicidal activity of C. militaris mycelium extract on larvae of P. xylostella moth.

Other natural extracts have also been tested in agriculture in recent years, particularly essential oils extracted from plants, which in many cases, however, have a dangerous eco-toxicological profile, with risk and hazard statements for both the environment and the operator; this profile is instead minimal with Cordyceps spp. mycelium.

Object of the present invention is therefore to provide a naturally occurring compound for use in agriculture, which guarantees an insecticidal activity while allowing to safeguard the human health and the environment.

### SUMMARY OF THE INVENTION

The invention therefore concerns the use of 9-(3-Deoxy-β-D-ribofuranosyl)adenine for killing an insect or pest, wherein said insect or pest is selected from the group consisting of an insect belonging to the order of Acari (or mites), the phylum of Nematoda and to the class of Gastropoda.

In a second aspect the invention concerns a non-therapeutic method for killing an insect present on a substrate, characterized by contacting said substrate with an effective amount of 9-(3-Deoxy-β-D-ribofuranosyl)adenine, wherein said insect is selected from the group consisting of an insect belonging to the order of Acari, the phylum of Nematoda and to the class of Gastropoda.

### DESCRIPTION OF THE DRAWINGS

FIG. 1 shows the photograph of an area of the leaf with Panonychus citri during treatment with the composition of the present invention;

FIG. 2 shows the photograph of an area of the leaf with Panonychus citri at 3 hours from the treatment with the composition of the present invention;

FIG. 3 shows the photograph of an area of the leaf with Panonychus ulmi adults before treatment;

FIG. 4 shows the photograph of an area of the leaf with Panonychus ulmi at 6 hours from the treatment with the composition of the present invention;

FIG. 5 shows the photograph of a Limax maximus adult snail before treatment with the composition of the present invention;

FIG. 6 shows the photograph of the mummified Limax maximus after treatment with the composition of the present invention.

FIG. 7 shows the results of the test performed on mites in the open field, as described in Example 3. The graph shows the percentage of efficacy (Henderson-Tilton's formula) calculated on number of young stages on 25 leaves. The efficacy against red mites (Tetranychus urticae) was tested in three different applications: a first application (A), a second application (B) 5 days after the second application and a third application (C) 7 days after the second application.

FIG. 8 shows the percentage of efficacy (Henderson-Tilton's formula) calculated on number of adults on 25 leaves. The efficacy was tested in a first application (A), a second application (B) 5 days after the second application and a third application (C) 7 days after the second application, as described in Example 3.

FIG. 9 shows a photo of the Plot N. 103-3, which is the untreated control, as described in Example 3.

FIG. 10 shows a photo of the Reference plot 203-3, which corresponds to the reference compound Neemik, as described in Example 3.

FIG. 11 shows a photo of the plot 303-3 which was treated with the Cordyceps extract, as described in Example 3.

FIG. 12A shows a photo taken at the microscope, of a live nematode before treatment, as described in Example 6.

FIG. 12B shows a photo taken at the microscope, of a dead nematode after treatment, as described in Example 6.

### DETAILED DESCRIPTION OF THE INVENTION

Kim J. R. et al (Pest.Manag.Sci.58 :713-717 (2002)) describe the larvicidal activity of C. militaris mycelium extract on larvae of P. xylostella moth. This extract, active on lepidoptera, was not found active on all juvenile stages of the tested insects. No significant effect was found on heteroptera (particularly Halyomorpha halys) or orthoptera (for example, Anacridium aegyptium).

The present invention concerns the use of 9-(3-Deoxy-β-D-ribofuranosyl)adenine for killing an insect or pest, wherein said insect or pest is selected from the group consisting of an insect or pest belonging to the order of Acari (also known as mites), the phylum of Nematoda and to the class of Gastropoda.

It has surprisingly been found that, although 9-(3-Deoxy-β-D-ribofuranosyl)adenine is not active on heteroptera and orthoptera, it has a strong pesticidal activity (insects, nematodes and slugs) on some insects or pests including mites, coleoptera, diptera, nematodes and gastropods.

Therefore, 9-(3-Deoxy-β-D-ribofuranosyl)adenine has pesticidal, insecticidal and acaricidal activity.

When the definition 9-(3-Deoxy-β-D-ribofuranosyl)adenine is used in the present invention, it is also intended to include cordycepin or 3-deoxyadenosine. The compound is a derivative of the nucleoside adenosine, which differs from it in the absence of an oxygen atom in position 3 of the ribose ring.

Cordycepin is extracted from a fungus of the genus Cordyceps spp. (in particular Cordyceps militaris ), or artificially synthesized. Its chemical formula is as follows:

[chemical structure]

Cordycepin may be used in pure or diluted form; a derivative thereof in the form of salt or an isomer may be used. The present invention encompasses the use of both the synthetic form of 9-(3-Deoxy-β-D-ribofuranosyl)adenine, and cordycepin extracted from the fungus Cordyceps spp. in the form of mycelium, spore, dry extract, or extract.

In a first aspect, in the use of 9-β-Deoxy-(3-D-ribofuranosyl)adenine, said insect or pest belonging to the order of Acari belongs to the genus Dermatophagoides, Panonychus and Tetranychus, to the families of Tarsonemidae (Polyphagotarsonemus latus), Tenuipalpidae (Brevipalpus phoenicis) and Parasitidae (Varroa destructor); and said insect belonging to the class of gastropods belongs to the genus Limax. Preferably said insect belonging to the class of gastropoda belongs to the species Limax maximus or Limax cinereoniger.

In a further aspect, in the use of 9-(3-Deoxy-β-D-ribofuranosyl)adenine, said insect belonging to the phylum Nematoda belongs to the class Secernentea or Adenophorea. Preferably, said insect belonging to the phylum Nematoda belongs to the genus Meloidogyne, Heterodera, Globodera or Xiphinema. More preferably said insect belonging to the phylum Nematoda belongs to the species Meloidogyne incognita, Heterodera spp, Globodera spp, Xiphinema index, Xiphinema italiae, Ditylenchus dipsaci.

The use of 9-(3-Deoxy-β-D-ribofuranosyl)adenine was also active for killing an insect belonging to the order of coleoptera, for example of the genus Chrysomelidae; an insect belonging to the order of diptera, for example of the genus Culex;

Performing laboratory tests with 9-β(3-Deoxy-β-D-ribofuranosyl)adenine, it was surprisingly found that it had an effect on juvenile stages and adults of acari, coleoptera (for example, chrysomelids), diptera, nematoda and gastropoda, while it had no significant effect on adult forms of heteroptera (Halyomorpha halys) or orthoptera (Anacridium aegyptium).

Surprisingly 9-(3-Deoxy-β-D-ribofuranosyl)adenine has both an insecticidal and an acaricidal activity. This dual activity is not common in other commercial products.

In fact many known pesticides such as pyrethrum, pyrethroids and phospho organic pesticides which are used for example, for their pesticidal activity on Diptera, Coleoptera and Lepidoptera, have undesired side effects.

Examples of these undesired side effects, which are caused by commercially available chemical pesticides and not by the 9-(3-Deoxy-β-D-ribofuranosyl)adenine compound of the invention are pesticide hormoligosis and trophobiosis (commonly known as mite resurgence).

Thus when using chemical pesticides, there is a tendency of the pests to adapt to the environment and provide an increased efficiency to develop new or better systems to cope in a suboptimum environment.

9-(3-Deoxy-β-D-ribofuranosyl)adenine surprisingly has pesticidal and acaricidal activity avoiding mite resurgence phenomena.

Having analysed the main microorganisms used for the control of insects/mites, we can confirm that the genus Cordyceps has a different mode of action and, given the dual effect both by contact and by ingestion, the low influence of temperature, the wide range of action based on pH, and the control of insects in the larval form, and mites in the form of a nymph or adult, it is an innovative solution for a sustainable agriculture, which allows also a minimum risk for the operator and the consumer, in addition to the lower environmental impact and selectivity towards pollinating insect.

In the tests carried out, the effect of the compound 9-(3-Deoxy-β-D-ribofuranosyl)adenine against the various insect following its ingestion by the larva was highlighted, but it had at the same time an effect through direct contact with the substance.

In a preferred form, said mites belong to a species selected from the group consisting in Dermatophagoides farinae, Dermatophagoides microceras, Dermatophagoides pteronyssinus, Panonychus citri, Panonychus ulmi, Tetranychus urticae, Eriophyes sheldoni, Phyticoptella avellana, Aculus schlechtendali, Calepitrimerus vitis, Eryophis pyri and Epitrimerus pyri.

In another aspect, the use of 9-(3-Deoxy-β-D-ribofuranosyl)adenine according to the present invention is for decontamination of domestic and public environments and surfaces thereof, and for decontamination of parks and gardens.

Domestic environments may be, for example, rooms, floors, furniture, doors. Examples of furniture may be beds, mattresses, pillows, rugs, curtains, sofas.

Advantageously, 9-(3-Deoxy-β-D-ribofuranosyl)adenine may be applied in the form of a ready-to-use (RTU) aqueous solution, with a dose of 9-(3-Deoxy-β-D-ribofuranosyl)adenine ranging from 0.005% to 10%, in the form of a RTU spray with an amount of 9-(3-Deoxy-β-D-ribofuranosyl)adenine ranging from 0.005% to 10%, in the form of a concentrated solution of 9-(3-Deoxy-β-D-ribofuranosyl)adenine to be subsequently diluted, in the form of a dry extract obtained from physical action on Cordyceps and subsequently diluted in water, in the form of spores of the genus Cordyceps subsequently diluted in water, in the form of glyceric extract of Cordyceps mycelium subsequently diluted in water, in the form of an organic solvent extract of the fungus of the genus Cordyceps subsequently diluted in water, in the form of mycelium dry extract used as a powder as is or mixed with co-formulants for the treatment of foodstuffs or seeds. 9-(3-Deoxy-β-D-ribofuranosyl)adenine or Cordycepin may be in the form of isomers and salts derivates thereof, such as cordycepin 5-triphosphate sodium salt, 2-deoxyadenosine 5-triphosphate disodium salt, and the possible salts deriving from the reaction with alkali metals.

Inside the mycelium of Cordyceps spp., two nucleosides, contained in lower amounts compared to the much more present Cordycepin were found, which differ for some functional groups, but which could potentially have an insecticidal effect. The two nucleosides are hydroxyethyl adenosine and dideoxyadenosine.

[chemical structure]

Given the characteristic of this substance and its easy availability and synthesis, it can be used in different formulation types:

formulation to be administered via the leaves having a larvicidal effect on Chrysomelidae;

formulation to be administered via the leaves having acaricidal effect;

formulation for domestic use;

bait formulation, used on larvae present in the soil, in pre-sowing, sowing, or at plants feet;

bait formulation for the control of Limacidae, thanks also to its low toxicity on mammals in the case of ingestion by pets;

effervescent formulation on Culex spp. larvae, for the treatment of stagnant water, manholes, or cisterns;

formulation to be administered in fertigation or in granules/powder to be distributed on soil for action on nematodes.

In a preferred form, the use of 9-(3-Deoxy-β-D-ribofuranosyl)adenine according to the present invention, is for decontamination of agricultural surfaces.

Examples of agricultural surfaces may be tree crops, cereal crops, fields, vegetable gardens, or agricultural land.

Advantageously, 9-(3-Deoxy-β-D-ribofuranosyl)adenine may be used for decontamination of a surface. Said surface is contacted with an effective amount of 9-(3-Deoxy-β-D-ribofuranosyl)adenine. In a preferred form, the effective amount of 9-(3-Deoxy-β-D-ribofuranosyl)adenine ranges from 0.001% to 20% w/w. In the present invention, “an effective amount” is intended as being the amount of 9-(3-Deoxy-β-D-ribofuranosyl)adenine which kills between 60% and 100% of the insects, preferably between 80% and 95%, more preferably between 85% and 95% of the insects or pests present on a surface or in an environment.

In a further aspect, the invention concerns a method for killing an insect or pest present on a substrate, characterized by contacting said substrate with an effective amount of 9-(3-Deoxy-β-D-ribofuranosyl)adenine, wherein said arthropod is selected from the group consisting in an arthropod belonging to the order of Acari (mites), the phylum of the Nematoda, the order of coleoptera, the order of diptera, and the class of Gastropoda.

In a preferred form, in the method according to the invention said substrate is a domestic environment or a surface thereof, a public environment or a surface thereof, a park, a garden or an agricultural environment or a surface thereof.

The following Examples of embodiments of the present invention are given below by way of illustration.

### EXAMPLES

### Example 1

The genus Cordyceps of entomopathogenic fungi include in all its species a molecule, 9-(3-deossi-β-D-ribofuranosyl)adenine, also named cordycepin. Both commercial formulations of pure cordycepin (purity ≥50% determined by HPLC analysis) and Cordyceps extracts, for example a glyceric extract of Cordyceps (G/L) were tested.

It was therefore demonstrated that the responsible for the death of insects in the larval form is indeed the active substance present in high amounts in the powder obtained from the fungus mycelium.

In particular, it is hypothesized that the activity on insects having chewing buccal apparatus is due (following ingestion) to cordycepin's gastric activity, a hypothesis which is also confirmed by the analysis of parasitizing insects of fungi belonging to this genus, also reported in a publication by Nnakumusana in 1985 in Uganda. (Histolological studies of Cordyceps myrmecophila infection in the ant Palthothyreus tarsatus). It seems, in fact, that this nucleoside poisons the insect and modifies its metabolism leading to an accumulation of calcium in the digestive tract, followed by the systemic development of the hyphae on all the other vital organs.

Preparation of 9-(3-deossi-β-D-ribofuranosyl)adenine.

The product called “OM”, an extract of Cordyceps militaris (M2 Ingredients, Carlsbad USA), a commercial formulation on the market as a food supplement, is used. It is a powder obtained from the mycelium of Cordyceps militaris, following a physical/mechanical treatment.

The commercial formulation is completely soluble in water up to a concentration of 20%. The solution is prepared after weighing 9-(3-deossi-β-D-ribofuranosyl)adenine in the form used, subsequently diluted in water and shaken by hand for a few seconds.

Preparation of a C. militaris Glyceric Extract

A suspension using 10 g of C. militaris in 100 g of pure glycerol is also prepared by mixing for 1 minute in a becker and leaving in extraction for 7 days, at constant room temperature (20° C.), without being concentrated.

The glyceric extract as is (Cordyceps-glycerol, hereinafter named C/G), is then diluted to 10% with water and sprayed on the leave surface, ensuring a complete wetting of the latter.

Preparation of a Mycelial Extract of C. militaris

Cordyceps dry extract is prepared by a physical process consisting in grinding the dry mycelium. Pure Cordyceps mycelial extract, ≥0.5% cordycepin (produced by Xi'an Chen Biological Technology) under the hypothesis of its use as is in agriculture.

### Example 2

Distribution of Preparations on Plants

The distribution may be carried out by means of a sprayer and an electric or manual sprayer pump, using a lance, an atomizer or an agricultural sprayer, and may be carried out thanks to the high solubility of the product by any means normally used in agriculture.

The distribution on the soil may be performed using the most common tools used in agriculture for the distribution of geo-disinfectants or fertilizers.

Distribution of Preparations on Surfaces

The distribution on surfaces, such as plastic, glass and ceramic, was tested using a spray, hypothesizing the possibility of using 9-(3-deossi-β-D-ribofuranosyl)adenine as RTU for domestic and civil use.

### Example 3

Test on Mites (Acari)

During the study phase of the mentioned active substance, any acaricidal or mite-repellent effects of the same were tested.

In particular, the effect of Cordyceps spp. produced by Xi'an Chen Biological Technology (≥0.5% Cordycepin declared), on Panonychus citri, present in the adult and nymph form on Citrus limon leaves, with an average presence of 4-5 adults per leaf, was tested.

Two theses, one with a concentration of 5 g of extract in 1000 mL of water (T1) and the other with 2.5 g of extract in 1000 mL of water (T2), were developed, dissolved and distributed by spray as such in the laboratory.

The results are shown in the table (Table 1).

TABLE 1
Test on P. citri adults

| | MORTALITY | MORTALITY |
|---|---|---|
| | AT 12 HOURS FROM | AT 24 HOURS FROM |
| THESIS | TREATMENT | TREATMENT |
| T1 | 95% | 98% |
| T2 | 60% | 90% |
| TEST. | 0% | 0% |

Furthermore, the application on leaves was tested on strawberries (Fragaria x ananassa, var. Alba), in field and greenhouse in the presence of adults of Tetranychus urticae, 2-4 adult forms per leaf, to test any potential phytotoxicity of the solution. The acaricidal efficacy was high, as reported on P. citri (Tab. 1), and no cytotoxicity damage or block of the vegetative activity were found following foliar administration of the extract, tested up to a dosage of 5 g of dry extract dissolved in one liter of water.

The effect of cordycepin on the adult form of Panonychus citri is very rapid. In addition, the mixture with tackifiers (heptamethyltrisiloxane and gluconic acid) was also tested: both improve the effectiveness and speed of action of the solution, improving leaf coverage, prolonging the toxic effect on the parasite, decreasing dripping.

The death of the adult spider was visible after a few hours with a change in colour from bright orange (FIG. 1) to red-brown. In the reported test, death was established following the lack of physical reaction by the mite to a stimulus with an external body (synthetic brush). In some cases, the effect is so fast that it does not lead to post-treatment mite displacement on the leaf surface. (FIG. 2) The treatment was performed using Cordyceps mycelial extract having a declared amount of cordycepin equal to 0.5%. The effect of the aqueous solution is therefore considerable, even at very low dosages of the same.

An improved effect was seen in the tests by increasing the parasite exposure time to the solution, an indication that it also has a contact/knockdown action. In fact, adult mite individuals that survived at 24 h after treatment (2-10% according to the thesis), did not reach death despite continuing to be in contact with the treated surface, an indication of low persistence of the active principle. The low persistence can be modified by using co-formulants/tackifiers, adjuvants or surfactant within the possible commercial formulation, and it is a positive characteristic given the minimal residual amount of the substance on edible crops.

In addition to the test described above, tests were carried out both in the laboratory and in the open field for the control of Panonychus ulmi moth; two theses were reproduced as in the test on P. citri, and the results were similar, reaching 90% efficacy on adult forms in 24 h. The theses were tested on flower crops (Rosacee, Liliacee, Asteracee), both in open field and greenhouse, to find any potential phytotoxicity of the formulation that was not found either on leaf or inflorescence, even with the addition of the mentioned tackifiers, adjuvants or co-formulants.

Efficacy of Cordyceps militaris Against Tetranychus urticae on Tomato Plant

The trial was set up in a farm sited in Rivergaro (PC), Emilia Romagna region, Northern Italy, in a typical open field tomato growing area. In this area the red mite pressure is very high and can lead to total loss of production.

The aim of the study was to evaluate the efficacy against Red mites (Tetranychus urticae) and the selectivity on the crop (Tomato, H1301) of Cordyceps militaris extract (also indicated as “C. M.”) applied at 4000 g/ha mixed with SOYBEAN OIL applied at 250 ml/ha compared to the reference product NEEMIK (Composition Azadiractina 0,6%) applied at 4000 ml/ha.

The first application (A) was performed on July 4th, when a uniform infestation across the trial area was observed and was followed by other two application on July 9th (B) (5 days after the first application) and July 16th (C) (7 days after the second application).

Seven assessments were performed during the trial period, checking for the presence of nymphs and adults separately on 25 leaves per plot. The leaves were observed in laboratory facility by means of a binocular microscope. In presence of a severe pressure of Red mites (Tetranychus urticae), as typical in the area where the trial was performed, the tested products Cordyceps militaris (C. M.)+SOYBEAN OIL, showed good performances against Red mites No phytotoxic symptoms were observed on the crop in all the treatments where the different products were applied, showing the full selectivity on tomato, H1301 variety.

Data from the assessments were analysed by variance analysis (ANOVA) with software ARM 2018.3 from Gylling Data Management, and shown in FIGS. 7 and 8. If significant effect of the treatment was obtained (on the basis of the ANOVA analysis) differences between means were checked with Student-Newman-Keuls (SNK) test (P=0.05).

In the case of data showing “treatment variances not homogeneous” (Bartlett's test for homogeneity), prior to the analysis the data were transformed with log(x+1), square root transformation of x+0,05 or arcsin √x+1 (% efficacy). Results obtained were indicated by a letter—treatment means with no letters in common are significantly different in accordance with a Student-Newman-Keuls (SNK) test conducted at a 95% confidence level.

Where data have been transformed, letters were included in the transformed data. The means reported are the original ones and the transformed ones.

4 days after the second application, the third assessment on leaves was performed. At this date, an average number of 75.8 adults and 27.3 young stages on 25 leaves was recorded on the untreated check. Both treatments showed numerically lower values than the untreated check in terms of young stages (22.5 on T2 and 15.0 on T3) while significantly differences were observed in terms of adults where the test products (C. M.+SOYBEAN OIL) recorded the lower number of adults on 25 leaves (20.0). NEEMIK recorded 62.5 adults on 25 leaves and results significantly similar to the untreated check and to the treatment T2. Efficacy values calculated according to Henderson-Tilton's formula ranged from 22.4% (T2—NEEMIK at 4000 ml/ha) to 54.8% (T3—C. M. at 4000 g/ha+SOYBEAN OIL at 250 ml/ha) for young stages and from 40.8% (T2—NEEMIK at 4000 ml/ha) to 67.1% (T3—C. M. at 4000 g/ha+SOYBEAN OIL at 250 ml/ha) for adults.

The experiments were performed using Cordyceps militaris formulated in Soybean oil. This choice was made to improve the distribution and to limit the evaporation and the photolysis of the microorganism.

The product used is based on Azadirachtin (Neemik), one of the few commercially available biological formulations that indicate the use on Red mites (Tetranychus urticae) on its label and is considered one of the possible substitutes of 9-(3-Deoxy-β-D-ribofuranosyl)adenine. FIGS. 9, 10 and 11 show the gap between the different thesis, indicating the efficacy of the Cordyceps militaris product (FIG. 11) in comparison to the untreated plot (FIG. 9) and the reference product (FIG. 10).

The photos of FIGS. 9, 10 and 11 were taken on 27.07.2018, 7 days after the last treatment, and show the different vegetative states of the three different thesis. The efficacy of the extract of Cordyceps militaris can be seen, in comparison to the untreated control and to the reference compound, and results in the data calculated with the Henderson-Tilton formula.

In particular the efficacy of the 9-(3-Deoxy-β-D-ribofuranosyl)adenine (Cordiceps militaris) can be seen at the beginning of pest infestation, where a very high efficacy in comparison to the reference compound is evident. The pesticidal activity of 9-(3-Deoxy-β-D-ribofuranosyl)adenine is surprisingly very high on the early stages of development.

### Example 4

Test on Gastropods

Tests were conducted on another phylum, Mollusca. In particular, on gastropods such as Limacidae, to test whether calcification of the digestive tract would also occur on these. (FIG. 3) The results were very similar; limacidae underwent slow death following trophic action of a bait made with bran and Cordyceps militaris mycelium (ratio 1:1 by weight), the harmful activity of the snails ceased within 24 hours; in this case there were no differences in colour, and limacidae reached death by dehydration on average after 4 days. (FIG. 4). Death by dehydration and stopping of nutrition by the gastropods leads to a process of “mummification” of the body, not allowing the unpleasant loss of liquids or decomposition of the common snailicide based on acetic metaldehyde. In all cases, even if the death of the parasite (insect or snail) occurred after more than 4 days, since the first hours a stop in the trophic activity and therefore of the damage to the crop (our technical objective) was seen.

### Example 5

Test on Chrysomelids

The effect of 9-(3-deossi-β-D-ribofuranosyl)adenine on the larval stage of Leptinotarsa decemlineata, present on potato leaf (Solanum tuberosum) with a presence of 4-5 larvae per plant, was tested. Two treatments, in the presence of the larval stage in open field, were performed 4 days apart using Cordyceps dry extract, at a dose of 10 grams per liter of water.

80% of the individuals present on the leaf surface were found to have died following two treatments, while no effect was found on adults of Leptinotarsa decemlineata, even if present in smaller number they continued the trophic action against the culture.

The homogeneous distribution of the product and its persistence on the treated surface were found to be of fundamental importance.

Test on Culex

The addition of various amounts of Cordyceps mycelium into a compound taken directly from a well containing stagnant water, having an average larval charge of 10 units per 0.5 liters of water, taken by dipper and subsequently placed in trays made of whitish plastic material to make the count easier, was tested. Mortality of larvae was seen, also at low amounts of Cordyceps spp. in the form of mycelium extract, administered in this thesis with various amounts of mycelium directly dissolved in water. These theses confirm that 9-(3-deossi-β-D-ribofuranosyl)adenine, has an efficacy on the larval forms of this insect and a potential use for the disinfestation of civil, public or agricultural areas, or for the control of Culicidae larvae in agricultural or civil outbreak areas.

From the detailed description and the Examples reported above, the advantages achieved by the use of 9-(3-deossi-β-D-ribofuranosyl)adenine of the present invention are apparent. In particular, such use has surprisingly and advantageously proved suitable for killing insects belonging to the order of mites, the order of coleoptera, and the class of gastropods. At the same time, such compound has the advantage of being of natural origin, thus not having the disadvantage of toxicity.

### Example 6

Test on Nematodes

Nematodes are very dangerous for crops, especially when these occur with high frequency on the same plots or ground, and especially in greenhouses. Nematodes cause significant damage at the root level, creating malformations (galls), reducing the root structure and consequently also the ability of absorbing water and nutrients.

The result is a strong loss of production that gets even worse as plants are unable to emit new adventitious roots.

In order to evaluate the efficacy of Cordyceps militaris as a biological nematode containment agent for the gall-nematode Meloidogyne incognita an experimental in vitro test was conducted using a mycelium solution containing 0.5% of 9-(3-Deoxy-β-D-ribofuranosyl)adenine.

A concentration of 5% in aqueous solution was tested on insegmented and embryonated eggs of M. incognita.

Efficacy of 9-(3-Deoxy-β-D-ribofuranosyl)adenine was demonstrated at the tested concentration allowing the inhibition of egg embryogenesis and a good action on free larvae included in the ovisacs. The tests carried out were conducted in vitro using small petri dishes, introducing 2 mL of the test solution with 5% of 9-(3-Deoxy-β-D-ribofuranosyl)adenine, or distilled water in the case of control. Incubation took place at a room temperature of 22° C. in the dark. The population of M. incognita came from plants grown in a field of rib chards.

Insegmented and embryonated eggs: the eggs were collected from the ovisacs and placed in petri dishes in the presence of the solution to be tested. Counts of hatched larvae were performed, for 7 days with daily control. A substantial difference was noted between the 9-(3-Deoxy-β-D-ribofuranosyl) adenine solution compared to the control (distilled water), as reported in the following table (Table 2 Efficacy of 9-(3-Deoxy-β-D-ribofuranosyl)adenine on M. incognita egg hatching, percentage of hatched larvae on a mean of 3 replicates.

TABLE 2

| TEST | 1 day | 2 days | 3 days | 4 days | 5 days | 6 days | 7 days |
|---|---|---|---|---|---|---|---|
| Cordyceps | 0 | 0 | 0 | 0 | 0 | 1% | 2% |
| 5% | | | | | | | |
| Control | 0 | 0% | 4% | 12% | 17% | 18% | 23% |

From the above it can be seen that 9-(3-Deoxy-β-D-ribofuranosyl)adenine showed a good nematocidal activity in vitro. We can thus affirm that it behaves as a nematodal biological control agent and may be used in the open field. The activity on nematodes can be seen especially in the early stages after implantation or transplantation of the plants, in which the nematode population is in the stage of eggs or larva II stage and allows a better efficacy from part of the mushroom.

In addition, the viability of nematodes of the genus Meloidogyne incognita at the adult stage (from a full field of rib chards) was tested. The adult specimens were placed on a glass slide after being isolated and observed with an optical microscope. FIG. 12A is a photo taken at the microscope, of the live nematode, which moved on the slide.

Once the viability of the nematode in question was confirmed, the nematocidal activity of 9-(3-Deoxy-β-D-ribofuranosyl)adenine was tested by placing the specimen in contact with one millilitre of solution containing 10% w/w of Cordyceps extract dissolved in water.

A high mortality rate (>90%) was found in the various microscopic observation tests in which individuals immersed in water were then reached by the test solution containing 9-(3-Deoxy-β-D-ribofuranosyl) adenine.

FIG. 12B shows a photo taken of a dead nematode, after treatment with 9-(3-Deoxy-β-D-ribofuranosyl) adenine.

1-14. (canceled)

15. A method for killing an insect or pest, the method comprising contacting the insect or pest with an amount of 9-(3-Deoxy-β-D-ribofuranosyl) adenine, or isomer or salt derivate thereof, effective to kill the insect or pest, wherein said insect is selected from the group consisting of an insect belonging to the order of Acari, the phylum of Nematoda and to the class of Gastropoda.

16. The method of claim 15, wherein said insect or pest belonging to the phylum Nematoda belongs to the class Secernentea or Adenophorea.

17. The method of claim 15, wherein said insect belonging to the phylum Nematoda belongs to the genus Meloidogyne, Heterodera, Globodera or Xiphinema.

18. The method of claim 15, wherein said insect belonging to the phylum Nematoda belongs to the species Meloidogyne spp., Heterodera spp, Globodera spp, Xiphinema index, Xiphinema italiae, Ditylenchus dipsaei.

19. The method of claim 15, wherein said insect belonging to the order of Acari belongs to the genus Dermatophagoides, Panonychus or Tetranychus, and said insect belonging to the class of Gastropoda belongs to the genus Limax.

20. The method of claim 15, wherein said insect belonging to the order of Acari belongs to a species selected from the group consisting of Dermatophagoides farinae, Dermatophagoides microceras, Dermatophagoides pteronyssinus, Panonychus citri, Panonychus ulmi, Tetranychus urticae, Eriophyes sheldoni, Phyticoptella avellana, Aculus schlechtendali, Calepitrimerus vitis, Eryophis pyri, Polyphagotarsonemus latus, Brevipalpus phoenicis, Varroa destructor and Epitrimerus pyri and to the families of Tarsonemidae, Tennipalpidae and Parasitidae.

21. The method of claim 15, wherein said insect belonging to the class of Gastropoda belongs to the species Limax maximus or Limax cineroniger.

22. The method of claim 15, wherein the method kills an insect or pest in a domestic or public environment, including on surfaces.

23. The method of claim 22, wherein the method is for decontaminating parks and gardens.

24. The method of claim 15, wherein the method kills an insect or pest on an agricultural surface.

25. The method of claim 22, wherein the surfaces are contacted with an effective amount of 9-(3-Deoxy-β-D-ribofuranosyl)adenine.

26. The method of claim 24, wherein the surface is contacted with an effective amount of 9-(3-Deoxy-β-D-ribofuranosypadenine.

27. The method of claim 25, wherein said effective amount of 9-(3-Deoxy-β-D-ribofuranosyl)adenine is an amount from 0.001% to 20% w/w.

28. The method of claim 26, wherein said effective amount of 9-(3-Deoxy-β-D-ribofuranosyl)adenine is an amount from 0.001% to 20% w/w.

29. A method for killing an insect or pest present on a substrate, characterized in that a substrate is contacted with an effective amount of 9-(3-Deoxy-β-D-ribofuranosyl)adenine, wherein said insect or pest is selected from the group consisting of an insect or pest belonging to the order of Acari, the phylum of Nematoda and the class of Gastropoda.

30. The method according to claim 29, wherein said substrate is a domestic environment or a surface thereof, a public environment or a surface thereof, a park, a garden, or an agricultural environment or a surface thereof.

31. The method according to claim 29, wherein said effective amount of 9-(3-Deoxy-β-D-ribofuranosyl)adenine is an amount from 0.001% to 20% w/w/.

32. The method according to claim 30, wherein said effective amount of 9-(3-Deoxy-β-D-ribofuranosyl)adenine is an amount from 0.001% to 20% w/w.
